(19) United States
(12) Patent Application Publication
(10) Pub. No.: US 2026/0295308 A1
(43) Pub. Date: Oct. 1, 2026

(54) Flow Valve

(71) Applicant: Dräger Safety AG & Co. KGaA, Lubeck (DE)

(72) Inventors: Alexander Miles Leonard, Whitley Bay (GB); Robert Miller, Whitley Bay (GB)

(21) Appl. No.: 19/630,950

(22) Filed: Mar. 27, 2026

(30) Foreign Application Priority Data
Mar. 27, 2025 (GB) 2504489.2

(51) Int. Cl. A62B 9/02

(52) U.S. Cl. CPC A62B 9/022

(57) ABSTRACT

A lung demand regulator flow valve for controlling a flow of breathing gas through a lung demand regulator and breathing apparatus may include a valve member configured to be displaced between a closed position in which the valve member seals against a valve seat of the flow valve, and an open position in which a breathing gas flow path is provided between the valve member and the valve seat. The valve member and/or the valve seat is shaped such that a cross-sectional area of the breathing gas flow path increases at a first rate during displacement of the valve member relative to the valve seat through a first displacement range, and the cross-sectional area of the breathing gas flow path increases at a second rate during displacement of the valve member relative to the valve seat through a second displacement range, the first rate being different to the second rate.

### CROSS-REFERENCE TO RELATED APPLICATION

This application claims priority to United Kingdom Patent Application No. 2504489.2 filed on Mar. 27, 2025 and entitled “Flow Valve,” the entirety of which is hereby incorporated by reference in its entirety for all non-limiting purposes.

### BACKGROUND

Self-contained breathing apparatus (SCBA) systems generally comprise a lung demand regulator (also referred to as LDR, ‘demand regulator’, or ‘regulator’) and a face mask. The regulator is connected to the face mask to provide a user with breathable air on demand. SCBA systems are often used by emergency service personnel such as firefighters, and are therefore often exposed to environments containing harmful contaminants such as smoke or toxic chemicals. These environments are often referred to as immediately dangerous to life or health (IDLH). Typically, a regulator used in a SCBA will be configured in a “positive pressure” mode. In other words, the regulator will be configured to maintain a positive pressure within the regulator and face mask to prevent any environmental contaminants from entering the SCBA system.

The pressure inside the regulator and the face mask will vary according to rate and depth of the user's breathing. Rapid deep breathing, such as the breathing of a user performing strenuous activity, will cause greater decreases in the pressure in the regulator and the face mask.

It will be appreciated that developments in regulators, particularly developments which more effectively maintain positive pressure, are desirable.

### SUMMARY

Various aspects of the present invention will now be described.

According to a first aspect, there is provided a lung demand regulator flow valve for controlling a flow of breathing gas through a lung demand regulator. The flow valve comprises a valve member configured to be displaced between a closed position in which the valve member seals against a valve seat of the flow valve, and an open position in which a breathing gas flow path is provided between the valve member and the valve seat. The valve member and/or the valve seat is shaped such that a cross-sectional area of the breathing gas flow path increases at a first rate during displacement of the valve member relative to the valve seat through a first displacement range, and the cross-sectional area of the breathing gas flow path increases at a second rate during displacement of the valve member relative to the valve seat through a second displacement range. The first rate is different to the second rate.

The valve member may be disposed in a valve bore. The valve member may be constrained to move linearly inside the valve bore.

The valve member may comprise an outer surface. The outer surface may comprise a first tapered portion and a second tapered portion. The first tapered portion and the second tapered portion may be arranged coaxially.

The first and second tapered portions may be arranged immediately axially adjacent. The first tapered portion may be arranged at a distal end of the outer surface. The second tapered portion may be arranged at a proximal end of the outer surface.

The distal end may be an end of the outer surface that faces a direction of displacement of the valve member when the valve member moves to the open position. The proximal end may be an end of the outer surface opposite the distal end.

The first tapered portion may be a conical tapered portion having a first diameter at its widest point and a second diameter at its narrowest point. The second tapered portion may be a conical tapered portion having a third diameter at its widest point and a fourth diameter at its narrowest point.

The first diameter may be between 9.5 mm and 10 mm. The first diameter may be between 9.8 mm and 10 mm. The first diameter may be 9.9 mm.

The second diameter may be between 7 mm and 9.5 mm. The second diameter may be between 9.3 mm and 9.5 mm. The second diameter may be 9.4 mm.

The third diameter may be between 6.5 mm and 7 mm. The third diameter may be between 6.6 mm and 6.9 mm. The third diameter maybe 6.7 mm.

The fourth diameter may be between 5.5 mm and 6.5 mm. The fourth diameter may be between 5.9 mm and 6.1 mm. The fourth diameter may be 6 mm.

References to the term ‘conical’ may include substantially conical, obliquely conical and/or frustoconical.

The second diameter and the third diameter may be equal such that the first tapered portion transitions continuously into the second tapered portion.

Reference to continuous transition between the first tapered portion and the second tapered portion will be understood to mean there is no discontinuous, discrete, or step-wise change between the first tapered portion and the second tapered portion.

The first tapered portion may have a first gradient relative to a displacement axis of the valve member. The second tapered portion may have a second gradient relative to the displacement axis of the valve member. The first gradient may be steeper than the second gradient.

It will be understood that the displacement axis of the valve member is the axis along which the valve member is displaced relative to the valve seat.

The cross-sectional area of the breathing gas flow path may be defined as an annular area extending radially between the valve seat and the outer surface of the valve member. The annular area may have an outer diameter equal to an inner diameter of the valve seat and an inner diameter equal to an outer diameter of the valve member.

The annular area may lie on a plane that is perpendicular with the displacement axis of the valve member.

The inner diameter of the annular area may vary according to the displacement of the valve member to vary the cross-sectional area of the breathing gas flow path.

A distal end of the valve member may comprise a beveled edge. The beveled edge may be beveled with a radius of between 4 mm and 6 mm. The radius may be 5 mm.

The flow valve may comprise valve bore in which the valve seat is disposed. The valve bore may comprise an inner surface. The inner surface may comprise a first tapered portion and a second tapered portion. The first tapered portion and the second tapered portion may be arranged coaxially.

The first and second tapered portions may be arranged immediately axially adjacent. The first tapered portion may be arranged at a distal end of the inner surface. The second tapered portion may be arranged at a proximal end of the inner surface. The distal end may be an end of the inner surface that is furthest from the valve member when the valve member is in the closed position. The proximal end may on an opposite end to the distal end.

The first tapered portion may be a conical tapered portion having a first diameter at its widest point and a second diameter at its narrowest point. The second tapered portion may be a conical tapered portion having a third diameter at its widest point and a fourth diameter at its narrowest point.

The first diameter may be between 9.5 mm and 10 mm. The first diameter may be between 9.8 mm and 10 mm. The first diameter may be 9.9 mm.

The second diameter may be between 7 mm and 9.5 mm. The second diameter may be between 9.3 mm and 9.5 mm. The second diameter may be 9.4 mm.

The third diameter may be between 6.5 mm and 7 mm. The third diameter may be between 6.6 mm and 6.9 mm. The third diameter maybe 6.7 mm.

The fourth diameter may be between 5.5 mm and 6.5 mm. The fourth diameter may be between 5.9 mm and 6.1 mm. The fourth diameter may be 6 mm.

The second diameter and the third diameter may be equal such that the first tapered portion transitions continuously into the second tapered portion.

The first tapered portion may have a first gradient relative to a longitudinal axis of the valve seat. The second tapered portion may have a second gradient relative to the longitudinal axis of the valve seat. The second gradient may be steeper than the first gradient.

The cross-sectional area of the breathing gas flow path may be defined as an annular area extending radially between the inner surface of the valve bore and an outer surface of the valve member. The annular area may have an outer diameter equal to an inner diameter of the valve seat and an inner diameter equal to an outer diameter of the valve member.

The outer diameter of the annular area may vary according to the displacement of the valve member relative to the valve seat to vary the cross-sectional area of the breathing gas flow path.

The outer diameter of the cross-sectional area may vary between 10.5 mm and 11.5 mm. The outer diameter of the cross-sectional area may vary between 10.9 mm and 11.1 mm. The outer diameter may be 11 mm. The inner diameter may vary between 9 mm and 9.5 mm. The inner diameter may vary between 9.1 mm and 9.3 mm. The inner diameter may be 9.2 mm.

The valve member may be configured to be displaced between 0 mm in the closed position of the valve member and 0.5 mm in the open position of the valve member.

The term ‘open position’ may refer to the fully or maximally open position of

the valve member.

The first rate of increase of the cross-sectional area of the breathing gas flow path may be between 4 mm²/mm and 6 mm²/mm. The first rate of increase of cross-sectional area of the breathing gas flow path may be between 4.024 mm²/mm and 5.989 mm²/mm.

The second rate of increase of the cross-sectional area of the breathing gas flow path may be between 0.5 mm²/mm and 2.5 mm²/mm. The second rate of increase of cross-sectional area of the breathing gas flow path may be between 1.017 mm²/mm and 2.027 mm²/mm.

Although the unit of the rate of increase in cross-sectional area is equivalent to millimeters (mm), the full, un-simplified unit is given for the purpose of clarity.

The first rate of increase in the cross-sectional area of the breathing gas flow path may be greater than the second rate of increase in the cross-sectional area of the breathing gas flow path.

The first tapered portion and/or the second tapered portion may comprise a flat tapered surface.

The first tapered portion and/or the second tapered portion may comprise a curved tapered surface. The or each curved tapered surface may be a concave tapered surface.

The first tapered portion and/or the second tapered portion may have any combination of flat tapered surfaces and curved tapered surfaces.

The first tapered portion and the second tapered portion may each comprise a concave tapered surface such that the rate of increase in cross-sectional area of the breathing gas flow path changes continuously with displacement of the valve member relative to the valve seat.

A tangent of the first tapered portion may be colinear with a tangent of the second tapered portion where the first tapered portion and the second tapered portion meet.

The flow valve may comprise a housing comprising a bore. The valve member may be arranged within the bore. The valve member may be configured to move axially with respect to the cylindrical housing within the bore.

According to a second aspect, there is provided lung demand regulator comprising: a flow valve according to the first aspect; a diaphragm exposed to an ambient pressure on a first side and an internal chamber of the lung demand regulator on a second side, the diaphragm being configured to flex according to a pressure differential between the first side and the second side; and a flow regulation mechanism coupled to the diaphragm and configured actuate the flow valve by displacing the valve member relative to the valve seat in response to flexing of the diaphragm when a pressure in the internal chamber falls below an ambient pressure.

Greater flexing of the diaphragm may cause greater displacement of the valve member. The valve member may be biased to return to the closed position when the pressure differential falls below a threshold.

### Biasing of the Valve Member May Be Provided by a Biasing Element.

A pressure differential of between 150 Pa and 200 Pa may cause displacement of the valve member such that the cross-sectional area of the breathing gas flow path is defined by at least the first tapered portion. A pressure differential of at least 200 Pa may cause displacement of the valve member such that the cross-sectional area of the breathing gas flow path is defined by at least the second tapered portion.

It will be appreciated that an increase in pressure differential across the diaphragm may cause an increase in displacement of the valve member. It will be appreciated that an increase in displacement of the valve member may cause the flow valve to be opened to a greater extent. It will be appreciated that as the valve member is displaced, the shape and size of the cross-sectional area of the breathing gas flow path may transition from initially being defined by the first tapered portion to being defined by the second tapered portion.

It will be appreciated that an increase in the cross-sectional area of the breathing gas flow path may lead to an increase in flow rate of breathing gas through the breathing gas flow path at a given pressure.

According to a further aspect, there is provided a breathing apparatus comprising a flow valve according to the first aspect or a lung demand regulator according to the second aspect.

### BRIEF DESCRIPTION OF THE DRAWINGS

Arrangements of the invention will now be described, by way of example, and with reference to the accompanying drawings, in which:

FIG. 1 shows a schematic view of a breathing apparatus according to an embodiment;

FIG. 2 shows a schematic view of a face mask and a lung demand regulator according to an embodiment;

FIG. 3 shows a cross-sectional view of a lung demand according to an embodiment; and

FIGS. 4A-4C, 5, and 6 show various embodiments of flow valves according to embodiments.

### DETAILED DESCRIPTION OF THE DRAWINGS

As discussed above, existing regulators can occasionally fail to adequately supply breathing gas at a rate sufficient to maintain a positive pressure when a user is breathing very deeply and rapidly. If the pressure inside the regulator and face mask decreases below the ambient pressure, there is a risk of harmful atmospheric contaminants being drawn into the face mask-putting the user at risk.

The present disclosure provides improvements over known regulator flow valves. More generally, the present disclosure provides improvements in breathing gas supply to reduce the likelihood of negative pressure inside a regulator.

The present disclosure relates to a lung demand regulator flow valve for controlling a flow of breathing gas through a lung demand regulator. The flow valve comprises a valve member which may be configured to be displaced between a closed position in which the valve member seals against a valve seat of the flow valve, and an open position in which a breathing gas flow path is provided between the valve member and the valve seat.

One or both of the valve member and the valve seat may be shaped such that a cross-sectional area of the breathing gas flow path increases at a first rate during displacement of the valve member relative to the valve seat through a first displacement range, and increases at a second rate during displacement of the valve member relative to the valve seat through a second displacement range. The first rate of displacement may be different to the second rate of displacement.

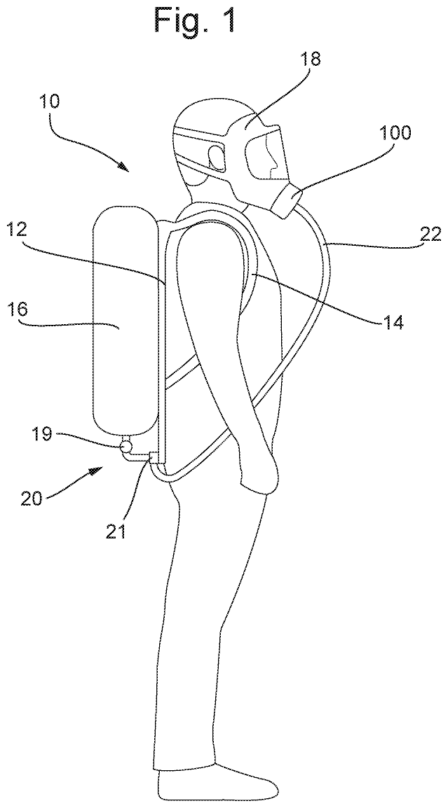

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a hose or flexible conduit 22 to the lung demand regulator 100, to thereby deliver breathing gas to the user wearing the face mask 18 on demand. The breathing apparatus 10 may further comprise other components or systems which are not shown, including but not limited to an electrical system, a monitoring system, or a communications system. The lung demand regulator 100 is referred to as the regulator 100 throughout.

In this illustrated arrangement, the breathing apparatus 10 is a self-contained breathing apparatus (SCBA), but it should be understood that the lung demand regulator may also have applications in other types of breathing apparatus, such as self-contained underwater breathing apparatus (SCUBA) and emergency escape breathing apparatus.

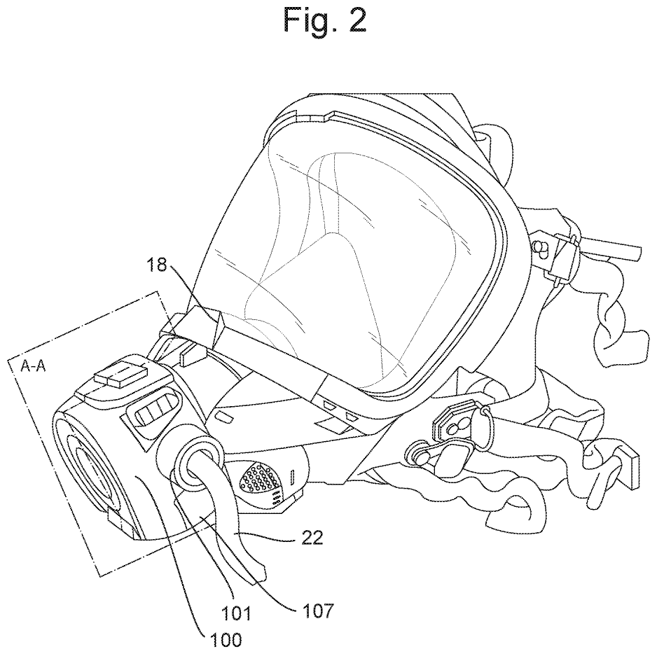

Turning to FIG. 2, a schematic view of the face mask 18 attached to the regulator 100 is shown. The hose 22 of the pneumatics system 20 is connected to an inlet 101 of the regulator 100 to provide breathing gas from the cylinder 16. The pneumatics system 20 may comprise a first-stage pressure reducer which reduces the pressure of the breathing air from the cylinder which may be stored at several hundred bar, to an intermediate pressure for provision to the regulator 100 via the hose 22. The intermediate pressure may be too high for the breathing gas to be provided directly to the user to breathe. The regulator 100 may further comprise a second-stage pressure reducer which further reduces the pressure of the breathing gas to a suitable pressure for delivery to the user to breathe. In other arrangements, more than two or fewer than two pressure reducers may be provided. In some arrangements, the regulator 100 is connected to a pressurised breathing gas circuit for workers to use, such as in a factory. In this case, the breathing gas may be provided by the circuit at a breathable pressure and so a pressure reducer may not be required.

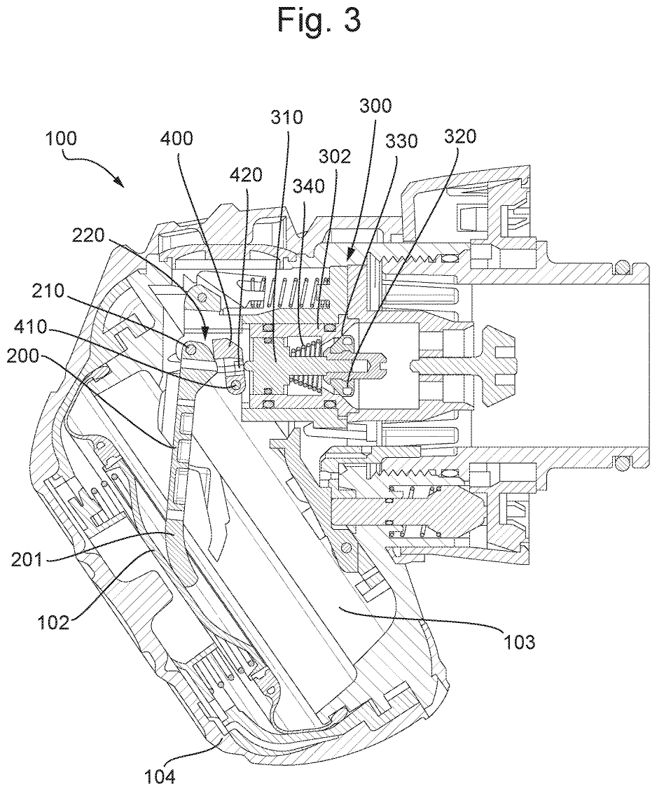

FIG. 3 shows a cross sectional view of the regulator 100, marked as ‘A-A’ in FIG. 2. The regulator 100 comprises a body 104, a diaphragm 102, a primary lever arm 200, and a flow valve 300. In the illustrated embodiment, the diaphragm 102 is a thin, flexible, impermeable membrane which is secured to the body 104. On one side, the diaphragm 102 is exposed to the ambient environment and therefore the ambient air pressure. On the other side, the diaphragm 102 is exposed to an internal cavity 103 formed in the body 104 of the regulator 100.

As the diaphragm 102 is formed of a flexible material, any difference in the ambient air pressure and the pressure of the internal cavity 103 causes the diaphragm 102 to flex. When the ambient pressure is greater than the internal cavity 103 pressure, the diaphragm 102 flexes inwards, towards the internal cavity 103. When the ambient pressure is less than the internal cavity 103 pressure, the diaphragm 102 flexes outwards, away from the internal cavity 103. The greater the difference between the ambient and internal cavity 103 pressures the greater the flexing of the diaphragm 102.

The primary lever arm 200 comprises a pivot point 210 about which the primary lever arm 200 is pivotable. The primary lever arm 200 is in communication with the flow valve 300 and pivoting of the primary lever arm 200 actuates the flow valve 300 (as will be described in more detail later), thereby controlling the introduction of pressurised breathing gas into the internal cavity 103. The primary lever arm 200 further comprises a foot 201 at an end of the primary lever arm 200 away from the pivot point 210. The foot 201 contacts the diaphragm 102. In the illustrated embodiment, the foot 201 contacts a substantially central portion of the diaphragm 102. The foot 201 may be positioned at an angle relative to the primary lever arm 200. When the diaphragm 102 flexes inwards towards the internal cavity 103, the diaphragm 102 pushes on the foot 201, causing the primary lever arm 200 to pivot about the pivot point 210.

According to the view shown in FIG. 3, the primary lever arm 200 pivots anticlockwise about the pivot point 210 as the diaphragm 102 flexes inwards. It will be appreciated that the extent to which the primary lever arm 200 pivots about the pivot point 210 corresponds to the extent to which the diaphragm 102 flexes inwards. Therefore, when the ambient air pressure is significantly greater than the pressure in the internal cavity 103, the diaphragm 102 will flex inwards significantly, causing a significant pivoting of the primary lever arm 200 about the pivot point 210. Equally, when the ambient air pressure is minimally greater than the pressure in the internal cavity 103, the diaphragm 102 will flex inwards minimally, causing a minimal pivoting of the primary lever arm 200 about the pivot point 210. The primary lever arm 200 can be biased (for example, by the flow valve 300) to pivot clockwise when the foot 201 is not in contact with the diaphragm 102. Therefore, when the diaphragm 102 flexes outwards after having flexed inwards and caused the primary lever arm 200 to pivot anticlockwise, the biasing will pivot the primary lever arm 200 clockwise so that the foot 201 remains in contact with the diaphragm 102.

When the regulator 100 is connected to the mask 18, the internal cavity 103 of the regulator 100 is in fluid communication with the inside of the mask 18. Therefore, when a user is wearing the mask 18, the act of the user inhaling causes a decrease in the pressure in the internal cavity 103. This decrease in pressure in the internal cavity 103 causes the diaphragm 102 moves inwards, causing the primary lever arm 200 to pivot. The pivoting of the primary lever arm 200 causes the flow valve 300 to open, resulting in breathing gas being introduced into the internal cavity 103 for the user to inhale. As the breathing gas is introduced, the pressure in the internal cavity 103 increases and eventually causes the diaphragm 102 to flex outwards, allowing the primary lever arm 200 to pivot back to its original position due to the biasing of the primary lever arm 200.

Changes in the user's activity or exertion levels can result in significant changes in their breathing characteristics. The rate and volume with which the user inhales directly impacts the rate at which the diaphragm 102 flexes inwards. Thus, the rate of rotation of the lever is correlated with the rate and volume with which the user inhales.

As shown in FIG. 3, the primary lever arm 200 comprises a cam element 220 proximal to the pivot point 210. The cam element 220 is formed by a proximal portion of the primary lever arm 200, which in this example is enlarged, and a surface around the proximal portion which is configured to actuate the flow valve 300 (whether via direct contact or indirectly, e.g., via a linkage) as the primary lever arm 200 pivots.

The primary lever arm 200 can contact the flow valve 300 directly. In this case, the cam element 220 of the primary lever arm 200 may contact a piston 310 of the flow valve 300 directly. In such embodiments, as the primary lever arm 200 pivots, the cam element 220 pushes against the piston 310. In this way, the piston 310 acts as a cam follower and moves laterally, causing a valve member 320 to lift off from a valve seat 330, allowing pressurised breathing gas to flow past the valve member 320 and into the internal cavity 103.

In some embodiments, including the embodiment shown in FIG. 3, the primary lever arm 200 may indirectly engage the piston 310 of the flow valve 300. In this case, a secondary lever arm 400 may be provided to form a linkage between the cam element 220 of the primary lever arm 200 and the piston 310. The secondary lever arm 400 may comprise a secondary pivot point 410, about which the secondary lever arm 400 can pivot. The secondary pivot point 410 may be arranged offset from the pivot point 210 of the primary lever arm 200. As is the case with the embodiment shown, the secondary lever arm 400 may be configured to pivot in the opposite direction to the direction of pivoting of the primary lever arm 200. In this way, as the primary lever arm 200 pivots anticlockwise, the cam element 220 may contact the secondary lever arm 400 and cause the secondary lever arm 400 to pivot clockwise. In some embodiments, the secondary lever arm 400 is an adjustable lever arm 400. In the embodiment shown, for instance, the secondary lever arm 400 includes a setting screw 420 which can be adjusted to vary an effective thickness of the secondary lever arm 400. Adjusting the effective thickness of the adjustable lever arm applies a “displacement offset” to a displacement conveyed from the cam element 220 of the primary lever arm 200 to the piston 310. Therefore, in this way the secondary lever arm 400 can be used to alter the angle at which the primary lever arm 200 must be pivoted to in order to cause the valve member 320 to lift off from the valve seat 330.

The valve member 320 is disposed within a cylindrical housing 302 of the flow valve 300. The valve member 320 is capable of being displaced between a closed position in which the valve member 320 seals against the valve seat 330 and an open position in which a breathing gas flow path is provided between the valve member and the valve seat. FIG. 3 shows the valve member 320 in the closed position.

The flow valve 300 may also comprise a biasing element 340 such as a helical spring. The biasing element 340 biases the valve member 320 to return to the valve seat 330 once the dynamic pressure of the breathing gas moving through the flow valve 300 (relative to the internal cavity 103 pressure) is no longer sufficient to hold the flow valve 300 open. In doing so, the biasing also causes the primary lever arm 200 to pivot clockwise around the pivot point 210.

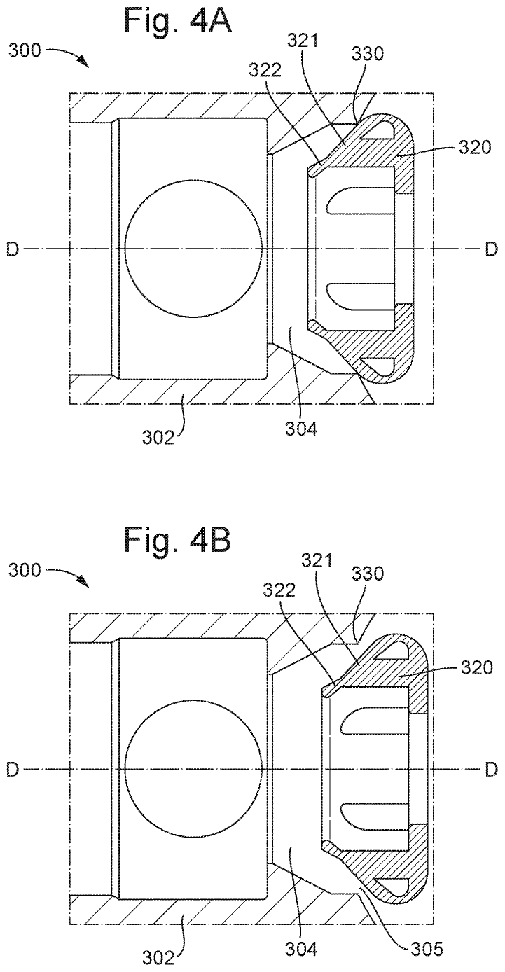

FIG. 4A shows an isolated, cross-sectional view of the valve member 320 within the flow valve 300. Other features of the flow valve 300, including the piston 310 have been hidden for simplicity. In FIG. 4A, the valve member 320 is shown in the same position as in FIG. 3. That is, the valve member 320 is shown in the closed position corresponding to the valve member 320 sealing against the valve seat 330.

The cylindrical housing 302 of the flow valve 300 comprises a bore 304 in which the valve member 320 is disposed. The valve member 320 is displaceable along a displacement axis D of the bore 304, shown in FIG. 4A. In the closed position of the valve member 320, the valve member 320 is positioned closer to the left side (or the proximal end of the bore 304) from the perspective of FIG. 4A. In the open position of the valve member 320, the valve member 320 is positioned closer to the right side (or the distal end of the bore 304) from the perspective of FIG. 4A.

The valve member 320 comprises an outer surface having a first tapered portion 321 and a second tapered portion 322. Each of the first tapered portion 321 and the second tapered portion 322 are arranged coaxially with one another and with the displacement axis D of the valve member 320. In some embodiments, including the embodiment shown, the first tapered portion 321 and the second tapered portion 322 are arranged immediately axially adjacent. That is to say, the first tapered portion 321 and the second tapered portion 322 are connected together.

In some embodiments, the first tapered portion and the second tapered portion may be eccentrically arranged relative to the displacement axis. That is to say, the first tapered portion and the second tapered portion may be offset from one another.

The first tapered portion 321 is arranged on a distal end of the outer surface of the valve member 320. The second tapered portion 322 is arranged on a proximal end of the outer surface of the valve member 320. The valve member 320 may comprise a beveled edge at its distal end.

The first tapered portion 321 is a conical tapered portion. The first tapered portion 321 has a first diameter at its widest point and a second diameter at its narrowest point. In the embodiment shown, the diameter of the first tapered portion 321 transitions linearly from the first diameter to the second diameter. The second tapered portion 322 is a conical tapered portion. The second tapered portion 322 has a third diameter at its widest point and a fourth diameter at its narrowest point. In the embodiment shown, the diameter of the second tapered portion 322 transitions linearly from the third diameter to the second diameter. References to the term conical may include obliquely conical and/or frustoconical.

By way of example, a typical valve member according to an embodiment of the present disclosure may comprise a first diameter between 9.5 mm and 10 mm. The first diameter may be between 9.8 mm and 10 mm. The first diameter may be 9.9 mm.

The second diameter may be between 7 mm and 9.5 mm. The second diameter may be between 9.3 mm and 9.5 mm. The second diameter may be 9.4 mm.

The third diameter may be between 6.5 mm and 7 mm. The third diameter may be between 6.6 mm and 6.9 mm. The third diameter maybe 6.7 mm.

The fourth diameter may be between 5.5 mm and 6.5 mm. The fourth diameter may be between 5.9 mm and 6.1 mm. The fourth diameter may be 6 mm.

Generally, the third and fourth diameters are less than the first and second diameters, respectively. In some embodiments, the second diameter and the third diameter may be equal such that the first tapered portion 321 may transition continuously into the second tapered portion 322. In other words, where the second and third diameters are equal, there may be no discontinuous, discrete, or step-wise change in diameter of the outer surface of the valve member 320 when transitioning from the first tapered portion 321 to the second tapered portion 322.

The gradient of the first tapered portion 321 relative to the displacement axis D may be greater or steeper than the gradient of the second tapered portion 322 relative to the displacement axis D. In other words, a rate of change in diameter of the first tapered portion 321 across the length of the first tapered portion 321 is greater than a rate of change in diameter of the second tapered portion 322 across the length of the second tapered portion 322. In some embodiments, the gradients may be linear or flat gradients. In some embodiments, one or more of the gradients may be non-linear gradients.

FIG. 4B shows the flow valve 300 in a partially open position. That is to say, FIG. 4B shows the valve member 320 in a position between the closed position and the open position. In other words, the valve member 320 is partially displaced between the closed position and the open position.

As a result of the partial displacement of the valve member 320, a breathing gas flow path 305 between the valve member 320 and the valve seat 330 is formed. The breathing gas flow path 305 (also referred to simply as the flow path 305) is formed around the valve member 320. In this embodiment, as the valve member 320 has a circular cross section and as the bore 304 has a circular cross section, the flow path 305 takes an annular shape. The annular area of the flow path 305 extends radially between the valve member 320 and the inner surface of the bore 304. An outer diameter of the flow path 305 is fixed and is defined by the inner surface of the bore 304 at the valve seat 330. An inner diameter of the flow path 305 is variable and is defined by the diameter of valve member 320 adjacent to the valve seat 330.

As the valve member 320 is displaced from the closed position to the open position, the diameter of the valve member 320 at the point adjacent to the valve seat 330 generally reduces. This reduction results in a corresponding increase in the internal diameter of the flow path 305. Given that the outer diameter of the flow path 305 is fixed, the increase in the inner diameter of the flow path 305 as the valve member 320 is displaced results in an increase in the cross-sectional area of the flow path 305.

It will be appreciated that, for a given gas pressure, an increase in cross-sectional area of the flow path 305 results in an increase in flow rate through the flow path 305. Therefore, as the valve member 320 is displaced from the closed position towards the open position the flow rate of breathing gas through the flow path 305 increases.

In FIG. 4B, the valve seat 330 is adjacent to the first tapered portion 321 of the valve member 320. As a result, the rate of change of the cross-sectional area of the flow path 305 is determined by the shape of the first tapered portion 321.

Displacement of the valve member 320 through the first displacement range corresponds to displacement of the valve member 320 across the length of the first tapered portion 321. Displacement of the valve member 320 through the second displacement range corresponds to displacement of the valve member 320 across the length of the second tapered portion 322.

Turning to FIG. 4C, the valve member 320 is shown in the open position. In this position, the valve seat 330 is adjacent to the second tapered portion 322. As a result, the rate of change of the cross-sectional area of the flow path 305 is determined by the shape of the second tapered portion 322.

Thus, it will be understood that the rate of change of the cross-sectional area of the flow path 305 is generally determined by the shapes of the first and second tapered portions 321, 322, and the displacement of the valve member 320.

As the first tapered portion 321 has a steeper gradient than the second tapered portion 322, the flow path 305 increases in cross-sectional area more rapidly as the valve member 320 is displaced through the length of the first tapered portion 321 than when the valve member 320 is displaced through the length of the second tapered portion 322.

As a result, when a user inhales, the initially small movement of the valve member 320 results in a more rapid increase in cross-sectional area than later movement of the valve member 320. In some embodiments, the more rapid increase in cross-sectional area may result in an increase in flow rate during the initial movement of the valve member of around 15%. The increase in flow rate during the initial movement of the valve member 320 results in more breathing gas being supplied to the face mask 18 more quickly. Therefore, if a user takes, for example, a rapid deep breath, the increased volume of breathing gas provided to the face mask 18 during the initial movement of the valve member 320 greatly reduces the likelihood of the user's inhalation causing pressure in the face mask 18 to fall below ambient pressure. Indeed, the shape of the outer surface of the valve member 320 is set so as to ensure pressure inside the face mask 18 can be maintained above ambient pressure even during periods of rapid deep breathing by the user.

As the user continues to inhale and the valve member 320 is displaced further, the cross-sectional area of the flow path 305 continues to increase, thereby ensuring more breathing gas is supplied. However, the rate at which the cross-sectional area increases changes as the flow path 305 transitions to being defined by the second tapered portion 322, rather than by the first tapered portion 321. Effectively, this results in the rate of increase of the flow rate of breathing gas into the face mask 18 slowing down as the user's inhalation nears its end. As a result, only the required amount of breathing gas is provided into the face mask 18, rather than providing an excess quantity which would be wasted.

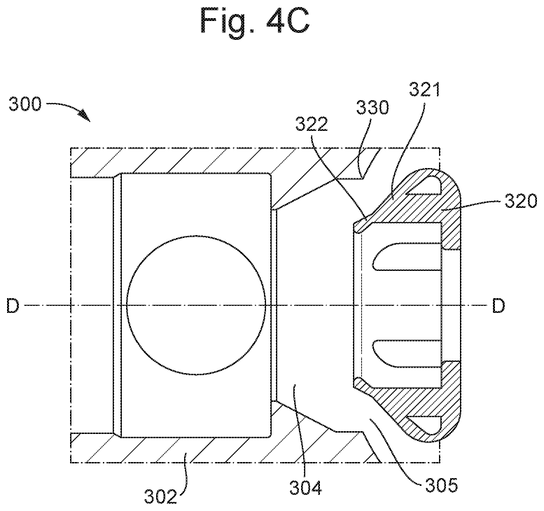

FIG. 5 shows another embodiment of a valve member 320′ according to the present disclosure. In this embodiment, the valve member 320′ includes a first tapered portion 321′ with a concave shape, and a second tapered portion 322′ with a concave shape. In this embodiment, the first tapered portion 321′ transitions continuously into the second tapered portion 322′. In other words, a tangent at an end point of the first tapered portion 321′ is colinear with a tangent at a start point of the second tapered portion 322′.

As shown, even though the first and second tapered portions 321′, 322′ are curved, the gradient of the first tapered portion 321′ relative to the displacement axis D is steeper along its entire length than the gradient of the second tapered portion 322′ at any point. As a result, initial displacement of the valve member 320′ results in a significant increase in breathing gas flow rate as described above in relation to the embodiment of FIGS. 4A-4C.

It will be appreciated that some embodiments may include more than two tapered portions that are connected together. For example, some embodiments may include three or four tapered portions.

As described above, the cross-sectional areas of the flow paths of all of the embodiments described thus far are defined by a fixed outer diameter and a variable inner diameter. Specifically, the outer diameter is defined by a fixed geometry of the inner surface of the bore 304 at the valve seat 330, and the inner diameter is defined by the varying diameter of the outer surface of the valve member along its length.

However, the present disclosure is not limited to such embodiments. In some embodiments, the outer diameter of the flow path may be variable in size, while the inner diameter may be fixed and/or variable.

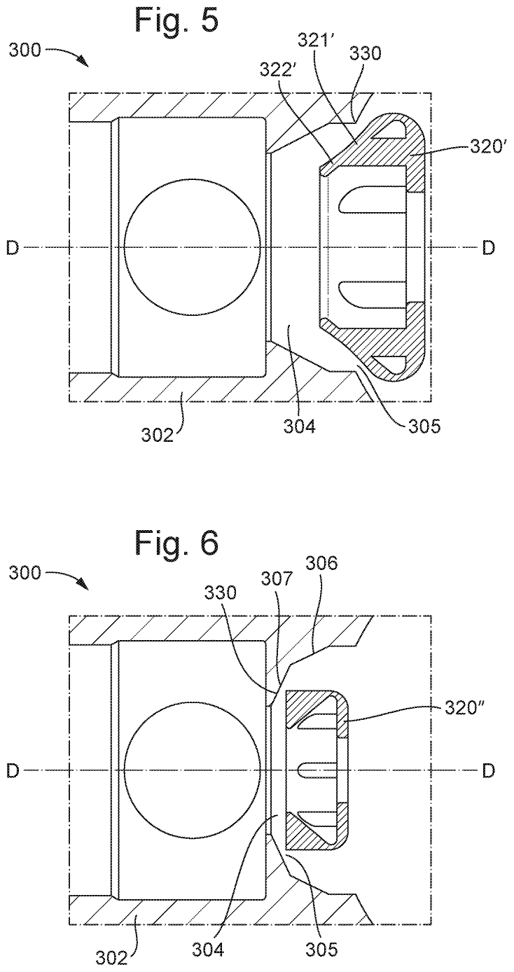

FIG. 6 shows one such an embodiment. In this embodiment, the valve member 320″ is shown in a position between the closed position and the open position. The valve member 320″ is generally cylindrical in shape, rather than tapered or conical as with the previous embodiments. The bore 304 includes multiple surfaces adjacent to the valve seat 330 which are angled relative to one another. In other words, the multiple adjacent surfaces define at least part of an inner surface of the bore 304.

In this embodiment, the bore 304 includes a first tapered portion 306 and a second tapered portion 307 which define at least part of an internal shape of the bore 304. The first tapered portion 306 is at a distal end of the bore 304 and the second tapered portion 307 is at a proximal end of the bore 304. The first tapered portion 306 and the second tapered portion 307 are arranged coaxially with one another and with the displacement axis D.

The first tapered portion 306 has a first diameter at its widest point and a second diameter at its narrowest point. The second tapered portion 307 has a third diameter at its widest point and a fourth diameter at its narrowest point.

Generally, the third and fourth diameters may be less than the first and second diameters, respectively. In some embodiments, the second diameter and the third diameter may be equal such that the first tapered portion 306 may transition continuously into the second tapered portion 307. In other words, where the second and third diameters are equal, there may be no discontinuous, discrete, or step-wise change in diameter of the inner surface of the bore when transitioning from the first tapered portion 306 to the second tapered portion 307.

The first tapered portion is a conical tapered portion. The second tapered portion is a conical tapered portion. The first diameter may be between 9.5 mm and 10 mm The first diameter may be between 9.8 mm and 10 mm. The first diameter may be 9.9 mm.

The second diameter may be between 7 mm and 9.5 mm. The second diameter may be between 9.3 mm and 9.5 mm. The second diameter may be 9.4 mm.

The third diameter may be between 6.5 mm and 7 mm. The third diameter may be between 6.6 mm and 6.9 mm. The third diameter maybe 6.7 mm.

The fourth diameter may be between 5.5 mm and 6.5 mm. The fourth diameter may be between 5.9 mm and 6.1 mm. The fourth diameter may be 6 mm.

The gradient of the second tapered portion 307 relative to the displacement axis D is steeper than the gradient of the first tapered portion 306 relative to the displacement axis D. In other words, a rate of change in diameter of the second tapered portion 307 across the length of the second tapered portion 307 is greater than a rate of change in diameter of the first tapered portion 306 across the length of the first tapered portion 306. In some embodiments, the gradients may be linear gradients. In some embodiments, one or more of the gradients may be non-linear gradients.

The embodiment shown in FIG. 6 functions similarly to the embodiments of the previous figures. As the valve member 320″ is displaced from the closed position to the open position, the outer diameter of the cross-sectional area of the flow path 305 transitions from being defined by the second tapered portion 307 to being defined by the first tapered portion 306. As the second tapered portion 307 has a steeper gradient than the first tapered portion 306, the rate of increase in the cross-sectional area of the flow path 305 is initially greater as the valve member 320″ is initially displaced. Then, as the valve member 320″ is displaced further to be adjacent to the first tapered portion 306, the rate of increase in the cross-sectional area of the flow path 305 reduces.

Of course, it will be appreciated that some embodiments of the present disclosure may include both the tapered portions of the embodiments of FIGS. 4A-4C as well as the tapered portions of FIG. 6.

The valve member of any of the embodiments described herein may be displaced by up to 0.5 mm. The first displacement range may be between 0 mm and 0.2 mm. The second displacement range may be at least 0.2 mm and may be between 0.2 mm and 0.3 mm.

The first rate of increase of the cross-sectional area of the breathing gas flow path may be between 4 mm²/mm and 6 mm²/mm. The first rate of increase of cross-sectional area of the breathing gas flow path may be between 4.024 mm²/mm and 5.989 mm²/mm.

The second rate of increase of the cross-sectional area of the breathing gas flow path may be between 0.5 mm²/mm and 2.5 mm²/mm. The second rate of increase of cross-sectional area of the breathing gas flow path may be between 1.017 mm²/mm and 2.027 mm²/mm.

All of the embodiments of the present disclosure provide more rapid introduction of breathing gas into a face mask immediately after they begin to inhale. By increasing the rate of introduction of breathing gas during this phase, the likelihood of the pressure inside the face mask falling below the ambient pressure is greatly reduced.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

1. A lung demand regulator flow valve for controlling a flow of breathing gas through a lung demand regulator, the flow valve comprising:
a valve member configured to be displaced between a closed position in which the valve member seals against a valve seat of the flow valve, and an open position in which a breathing gas flow path is provided between the valve member and the valve seat;
wherein the valve member and/or the valve seat is shaped such that a cross-sectional area of the breathing gas flow path increases at a first rate during displacement of the valve member relative to the valve seat through a first displacement range, and the cross-sectional area of the breathing gas flow path increases at a second rate during displacement of the valve member relative to the valve seat through a second displacement range, the first rate being different to the second rate.

2. The flow valve of claim 1, wherein the valve member comprises an outer surface, the outer surface comprising a first tapered portion and a second tapered portion, the first tapered portion and the second tapered portion being arranged coaxially.

3. The flow valve of claim 2, wherein the first tapered portion is a conical tapered portion having a first diameter at its widest point and a second diameter at its narrowest point, and the second tapered portion is a conical tapered portion having a third diameter at its widest point and a fourth diameter at its narrowest point.

4. The flow valve of claim 3, wherein the second diameter and the third diameter are equal such that the first tapered portion transitions continuously into the second tapered portion.

5. The flow valve of claim 2, wherein the first tapered portion has a first gradient relative to a displacement axis of the valve member and the second tapered portion has a second gradient relative to the displacement axis of the valve member, the first gradient being steeper than the second gradient.

6. The flow valve of claim 2, wherein the cross-sectional area of the breathing gas flow path is defined as an annular area extending radially between the valve seat and the outer surface of the valve member, the annular area having an outer diameter equal to an inner diameter of the valve seat and an inner diameter equal to an outer diameter of the valve member.

7. The flow valve of claim 6, wherein an inner diameter of the annular area varies according to the displacement of the valve member to vary the cross-sectional area of the breathing gas flow path.

8. The flow valve of claim 1, wherein a distal end of the valve member comprises a beveled edge.

9. The flow valve of claim 1, further comprising a valve bore in which the valve seat is disposed, the valve bore comprising an inner surface, the inner surface comprising a first tapered portion and a second tapered portion, the first tapered portion and the second tapered portion being arranged coaxially.

10. The flow valve of claim 9, wherein the first tapered portion is a conical tapered portion having a first diameter at its widest point and a second diameter at its narrowest point, and the second tapered portion is a conical tapered portion having a third diameter at its widest point and a fourth diameter at its narrowest point.

11. The flow valve of claim 10, wherein the second diameter and the third diameter are equal such that the first tapered portion transitions continuously into the second tapered portion.

12. The flow valve of claim 10, wherein the first tapered portion has a first gradient relative to a longitudinal axis of the valve seat and the second tapered portion has a second gradient relative to the longitudinal axis of the valve seat, the second gradient being steeper than the first gradient.

13. The flow valve of claim 9, wherein the cross-sectional area of the breathing gas flow path is defined as an annular area extending radially between the inner surface of the valve bore and an outer surface of the valve member, the annular area having an outer diameter equal to an inner diameter of the valve seat and an inner diameter equal to an outer diameter of the valve member, and wherein the outer diameter of the annular area varies according to the displacement of the valve member relative to the valve seat to vary the cross-sectional area of the breathing gas flow path.

14. (canceled)

15. (canceled)

16. (canceled)

17. (canceled)

18. The flow valve of claim 2, wherein the first rate of increase in the cross-sectional area of the breathing gas flow path is greater than the second rate of increase in the cross-sectional area of the breathing gas flow path.

19. The flow valve of claim 2, wherein the first tapered portion and/or the second tapered portion comprises a flat or curved tapered surface.

20. (canceled)

21. The flow valve of claim 2, wherein the first tapered portion and the second tapered portion each comprise a concave tapered surface such that the rate of increase in cross-sectional area of the breathing gas flow path changes continuously with displacement of the valve member relative to the valve seat.

22. The flow valve of claim 1, comprising a housing comprising a bore, wherein the valve member is arranged within the bore, and wherein the valve member is configured to move axially with respect to a cylindrical housing within the bore.

23. A lung demand regulator comprising:
a flow valve comprising a valve member configured to be displaced between a closed position in which the valve member seals against a valve seat of the flow valve, and an open position in which a breathing gas flow path is provided between the valve member and the valve seat; wherein the valve member and/or the valve seat is shaped such that a cross-sectional area of the breathing gas flow path increases at a first rate during displacement of the valve member relative to the valve seat through a first displacement range, and the cross-sectional area of the breathing gas flow path increases at a second rate during displacement of the valve member relative to the valve seat through a second displacement range, the first rate being different to the second rate; the valve member comprises an outer surface, the outer surface comprising a first tapered portion and a second tapered portion, the first tapered portion and the second tapered portion being arranged coaxially;
a diaphragm exposed to an ambient pressure on a first side and an internal chamber of the lung demand regulator on a second side, the diaphragm being configured to flex according to a pressure differential between the first side and the second side; and
a flow regulation mechanism coupled to the diaphragm and configured actuate the flow valve by displacing the valve member relative to the valve seat in response to flexing of the diaphragm when a pressure in the internal chamber falls below an ambient pressure;
wherein greater flexing of the diaphragm causes greater displacement of the valve member; and
wherein the valve member is biased to return to the closed position when the pressure differential falls below a threshold.

24. (canceled)

25. A breathing apparatus comprising a flow valve according to claim 1.

26. A breathing apparatus comprising a lung demand regulator according to claim 23.
